(19) United States
(12) Patent Application Publication
(10) Pub. No.: US 2008/0303830 A1
(43) Pub. Date: Dec. 11, 2008

(54) Automatic feature mapping in inheritance based avatar generation

(75) Inventors: Michel Fleury, Montreal (CA); David Chamandy, Montreal (CA)

Correspondence Address: FREEDMAN & ASSOCIATES, 117 CENTREPOINTE DRIVE, SUITE 350, NEPEAN, ONTARIO, K2G 5X3, CA

(73) Assignee: Darwin Dimensions Inc., Montreal (CA)

(21) Appl. No.: 12/155,727

(22) Filed: Jun. 9, 2008

Related U.S. Application Data
(60) Provisional application No. 60/929,055, filed on Jun. 11, 2007.

(51) Int. Cl. G06T 15/70

(52) U.S. Cl. 345/473

(57) ABSTRACT

The generation of characters within computer animations is currently a labor intensive and expensive activity for a wide range of businesses. Whereas prior art approaches have sought to reduce this loading by providing reference avatars, these do not fundamentally overcome the intensive steps in generating these reference avatars, and they provide limited variations. According to the invention a user is provided with a simple and intuitive mechanism to affect the weightings applied in establishing the physical characteristics of an avatar generated using an inheritance based avatar generator. The inheritance based generator allowing, for example, the user to select a first generation of four grandparents, affect the weightings in generating the second generation parents, and affect the weightings in generating the third generation off-spring avatar from these parents. Accordingly the invention provides animators with a means of rapidly generating and refining the off-spring avatar to provide the character for their animated audio-visual content.

This application claims the benefit of U.S. Provisional Application No. 60/929,055 filed on Jun. 11, 2007, the entire content of which is incorporated herein by reference.

### FIELD OF THE INVENTION

The invention relates to computer graphics and more particularly to computer character generation for use in animation.

### BACKGROUND OF THE INVENTION

Computer animation, the art of creating moving images via the use of computers, is a common form of audio-visual presentation, where the provided content ranges from television programming, television advertisements, feature movies, short films, cartoons, music videos, computer games and video games. Further these different forms of computer animation, traditionally presented to the user via a television or within the movie theatre are now presented with, and supported by, a multitude of electronic devices including personal computers (PCs), laptop computers, Personal Digital Assistant (PDA), video game consoles (consoles), handheld game consoles (handhelds), cellular telephones (cellphones), and portable multimedia players.

Economically, such computer animation in the form of physical and online sales represents a global business today of approximately $40 billion in 2006 and expected to grow to over $65 billion by 2010. The dominant segments of this market being computer animated feature films, computer games, console games and handheld games.

In addition to this significant global economic element of “entertainment oriented animation” there is an immense amount of animation generated by individuals and businesses for a wide variety of uses ranging from advertisements, education, etc. Whilst difficult to provide economics, an estimate of the quantity of such material may be estimated from quick searches using Yahoo and Google, within their specific video databases for animations. Such searches return 153,000 and 98,000 animated videos as of Jun. 5, 2007.

In computer animation, commercially available systems are essentially digital successors to the art of stop motion animation of 3D models and frame-by-frame animation of 2D illustrations. Some examples of current animation software include Amorphium®, Art of Illusion®, Poser®, Ray Dream Studio®, Bryce®, Maya®, Blender®, TrueSpace®, Lightwave®, 3D Studio Max®, SoftImage XSI®, Alice®, and Adobe Flash® (2D).

For 3D animations of characters, the characters are modeled on the computer monitor and 3D figures are rigged with a virtual skeleton. For 2D figure animations, separate illustrations and separate transparent layers are used, with or without a virtual skeleton. Then the limbs, eyes, mouth, clothes, etc. of the figure are moved by the animator on key frames. The differences in appearance between key frames are automatically calculated by the computer in a process known as tweening or morphing. Finally, the animation is rendered, the rendering providing the features of the skin, clothing, etc.

It would be apparent that within the thousands of different computer game titles and tens of thousands of different animated videos that a significant amount of work is expended in generating the virtual skeletons, providing the character models, and rendering the physical forms of the characters. Presently, this is typically done by specialised artists. This has a corresponding cost to a studio or animator in producing the audio-visual content with computer animation. These costs increase essentially linearly with the number of characters, as they are all generated individually, and with the degree of resolution applied in generating the models. For example, characters within background may be modelled and rendered at low resolution, whilst characters in foreground modelled and rendered at high resolution, particularly the main characters. The lower complexity of generating a wide variety of characters such as fantasy

Numerous other embodiments may be envisaged without departing from the spirit or scope of the invention. characters and cartoon-like humans influences the decisions that studios, animators and others make in generating their computer animation. Even so the costs of generating computer animated characters are significant and clearly evident when one considers that even animated films with fantasy characters and cartoon-like humans such as “Shark Tale”, “Toy Story 2”, “Incredibles” and “Finding Nemo” have production costs ranging from US$80 million to over US$100 million per motion picture.

Throughout the remainder of this document the term “avatar” is employed to refer to a computer animated character. Originating from video games, “avatars” are essentially a player's physical computer animated representation in the game world. Typically, a video game offers the player a single avatar or a predetermined limited set of avatars from which to select as the basis of their “player” within the game. As such these avatars have been generated typically in accordance with the process presented stipra in respect of skeletons, wire-frames, and rendering. Online games such as “Second Life” provide only 12 avatars for the user to select from, whilst video games such as “Alien Arena 2007” (COR Entertainment) offers 11 avatars for the player to base their player upon.

Recently, to reduce the complexity for animators in generating avatars for their audio-visual content, some commercial software suites offer the animator such a library of stock avatars to select from. One such leading commercial software suite being “iClone 2.0” from RealIllusion, which offers 15 base avatars for the animator to select from. Unfortunately, this is very limited.

It would therefore be beneficial to provide a way for an animator to rapidly generate an avatar and manipulate their characteristics. Further, rather than requiring the animator to always envision, provide a skeleton, wire frame and render their avatar completely it would be beneficial to provide a solution offering the animator the ability to start or select a relatively small number of input selections, and provide simple intuitive interfaces allowing them to focus their creative skills on the manipulation and refinement of the avatar, whilst offering them a wide range of potential outcomes.

### SUMMARY OF EMBODIMENTS OF THE INVENTION

The instant application hereby incorporates by reference the entire contents of U.S. Provisional Patent Application No. 60/929,055, filed on Jun. 11, 2007.

In accordance with an aspect of the invention there is provided a method comprising: providing at least two avatars, each one of the at least two avatars having a different simulated physical appearance that is defined in terms of a plurality of inheritable characteristics; providing a weighting factor for defining a relative contribution of at least one of the plurality of inheritable characteristics from each of the at least two avatars to a simulated physical appearance of an Off-Spring avatar, the weighting factor selected by a user; generating the Off-Spring avatar in dependence upon the plurality of inheritable characteristics of the at least two avatars and the weighting factor; providing an additional item for being associated with the Off-Spring avatar; modifying the Off-Spring avatar to form a new avatar, the new avatar formed by mapping the additional item onto the Off-Spring avatar; and storing the new avatar on a computer readable storage medium.

In accordance with an aspect of the invention there is provided a method comprising:
(a) providing a current generation of avatars comprising at least two different avatars, each of the at least two different avatars having at least one physical characteristic contributing to a unique simulated physical appearance thereof,
(b) receiving from a user a weighting factor for establishing a weighting in combining the physical characteristic of the at least two different avatars of the current generation of avatars;
(c) executing an inheritance based avatar generation process for generating a next generation avatar, the physical characteristic of the next generation avatar being established in dependence upon the physical characteristic of the at least two different avatars of the current generation of avatars and the weighting factor;
(d) providing an additional item for being associated with the next generation avatar;
(e) providing a new avatar, the new avatar being generated by mapping the additional item onto the next generation avatar; and
(f) storing the new avatar on a computer readable storage medium

In accordance with an aspect of the invention there is provided a method comprising: providing a virtual environment, the virtual environment supporting a plurality of avatars associated with a plurality of users, each avatar having a plurality of physical characteristics; providing within the virtual environment an ability for at least two avatars of the plurality of avatars to have an Off-Spring avatar, the Off-Spring avatar generated in dependence upon the plurality of physical characteristics of the at least two avatars; providing an additional item for being associated with the Off-Spring avatar, the additional item being selected by at least one user associated with the at least two avatars; modifying the Off-Spring avatar to provide a modified Off-Spring avatar, the modified Off-Spring avatar generated by mapping the additional item onto the Off-Spring avatar, and, storing the modified Off-Spring avatar on a computer readable storage medium.

### BRIEF DESCRIPTION OF THE DRAWINGS

Exemplary embodiments of the invention will now be described in conjunction with the following drawings, in which:

FIG. 1 illustrates a prior art approach to generating an avatar using a wire-frame model and polygon filling;

FIG. 2A illustrates a first user view of a prior art software package providing pre-generated avatars for video game programmers;

FIG. 2B illustrates a second user view of a prior art software package providing pre-generated avatars highlighting the predetermined features of each avatar;

FIG. 3 illustrates a three-generation inheritance based avatar generator according to an embodiment of the invention for weighting grandparents for each parent and between parental families;

FIG. 4 illustrates the three-generation inheritance based avatar generator of FIG. 3 highlighting the slider-bars provide alternate weighting, thereby favoring grandfathers;

FIG. 5 illustrates an exemplary embodiment of the invention employed in generating an inheritance based avatar for a second step of the body generation;

FIG. 6 illustrates three inheritance based avatars generated using an inheritance based software generator according to an embodiment of the invention to provide dynamic adjustment of the body in the second step;

FIG. 7 illustrates a three-generation inheritance based avatar generator according to the invention for a third step of providing non-physical features of the avatar; and

FIG. 8 illustrates the three-generation inheritance based avatar generator output according to the invention wherein the selected non-physical features are automatically mapped to the adjustments in the avatar from the first and second steps relating to the physical characteristics.

### DETAILED DESCRIPTION OF EMBODIMENTS OF THE INVENTION

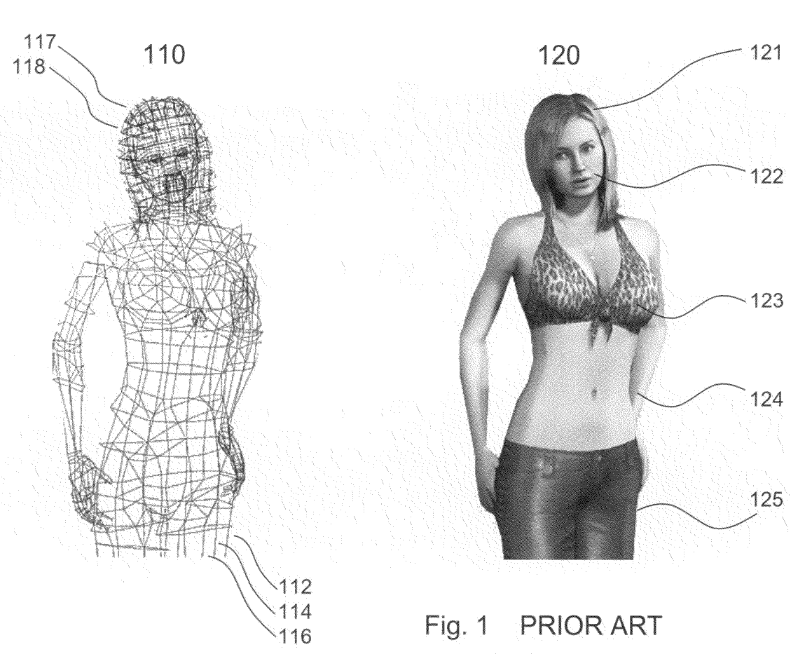

Referring to FIG. 1 illustrated is a prior art approach to generating an avatar using a wire-frame model 110 and finished model 120. The wire-frame model 110 is typically generated by the avatar programmer and consists of polygons, such as coarse polygons 112 through 116 in regions of general body shape, and fine polygons 117 and 118 in regions of the body requiring more detail. After completing the wire-frame model 110 the avatar programmer selects the fill for the coarse polygons 112 through 116 and fine polygons 117 and 118 according to the clothing and body of the avatar being generated.

As shown in FIG. 1, the polygons of wire-frame model 110 are filled according to hair 121, face features 122, bikini top 123, body 124 and trousers 125, therein resulting in the finished model 120. The finished model 120 is then stored by the avatar programmer for use within a video game, computer game or other animated audio-visual content.

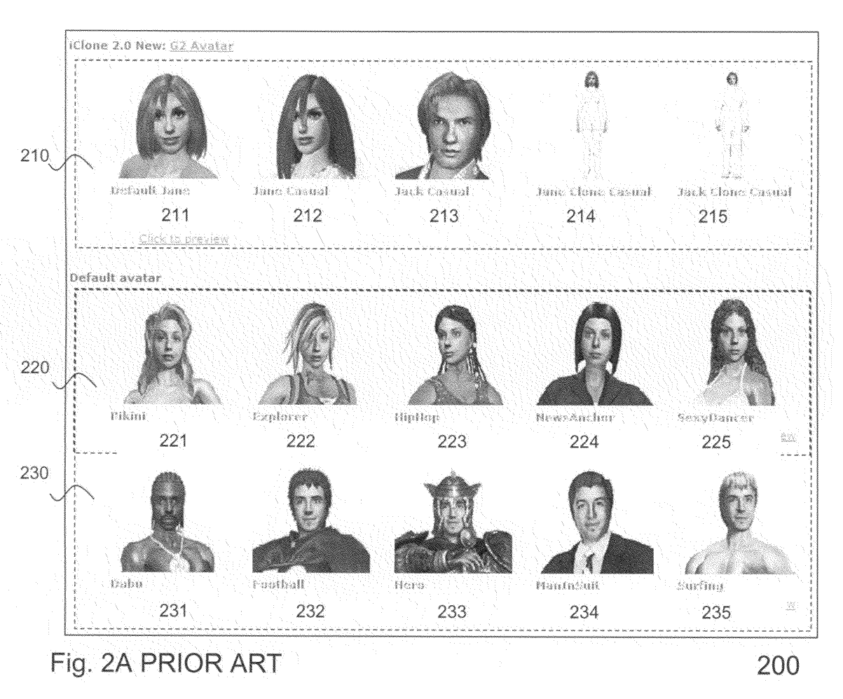

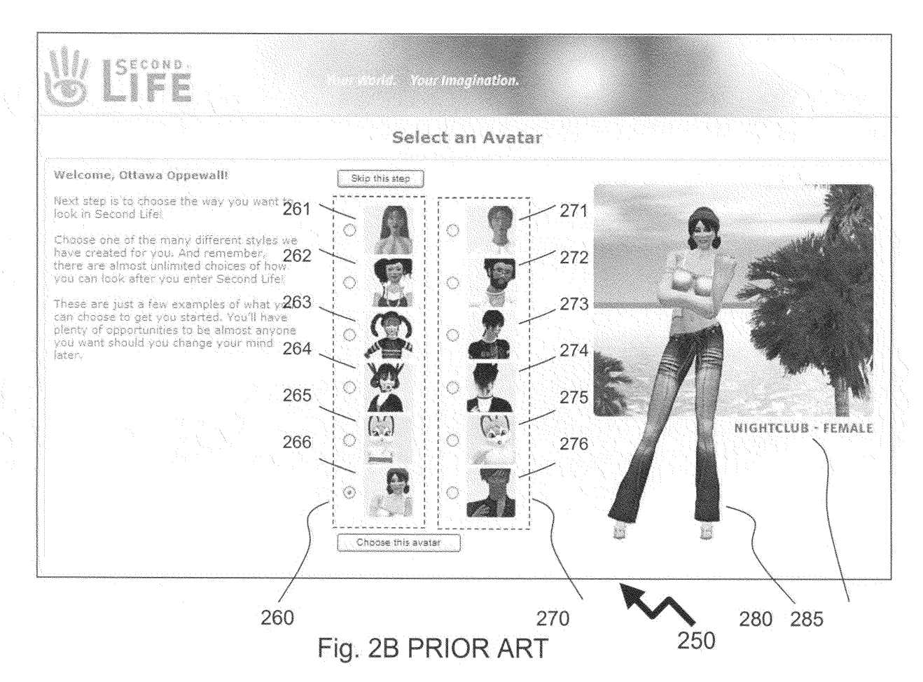

With the proliferation of video games, computer games, animated films, etc. an organization generating such content may not wish to expend its resources, financial or physical, in generating avatars. As a result an aspect of the industry is the purchase of pre-designed avatars from an avatar-programmer, such as referred to in FIG. 1 generating the finished model 120. An example of an avatar menu 200 is shown in FIG. 2A from the commercial avatar set “iClone 2.0” from iClone Inc. As such the purchaser of the avatar set “iClone 2.0” is presented with an avatar menu 200 comprising three groups, the first being “G2 Avatar” 210, the second “Girl Avatar” 220, and finally “Boy Avatar” 230. Within the “G2 Avatar” 210 group are three complete avatars, similar to finished model 120 of FIG. 1, being “Default Jane” 211, “Jane Casual” 212, and “Jack Casual” 213. Also within the “G2 Avatar” 210 are partially completed avatars “Jane Clone Casual” 214 and “Jack Clone Casual” 215 which have blank clothing but completed heads and facial features.

“Girl Avatar” 220 as shown comprises clothed and completed models, similar to finished model 120 of FIG. 1 using the “Jane” figure as employed in “Default Jane” 211, “Jane Casual” 212 and “Jane Clone Casual” 214. As such, shown are “Bikini” 221, “Explorer” 222, “HipHop” 223, “News Anchor” 224, and “Sexy Dancer” 225. Similarly “Boy Avatar” 230 as shown comprises clothed and completed models, similar to finished model 120 of FIG. 1 using the “Jack” figure as employed in “Default Jack” 213 and “Jack Clone Casual” 215. As such, shown are “Dabu” 231, “Football” 232, “Hero” 233, “Man in Suit” 234, and “Surfing” 235. It would be apparent to the reader that in some instances the avatars by being generated from common source avatars, such as “Jane Clone Casual” 214 and “Jack Clone Casual” 215, have not been executed flawlessly, see for example “Surfing” 235.

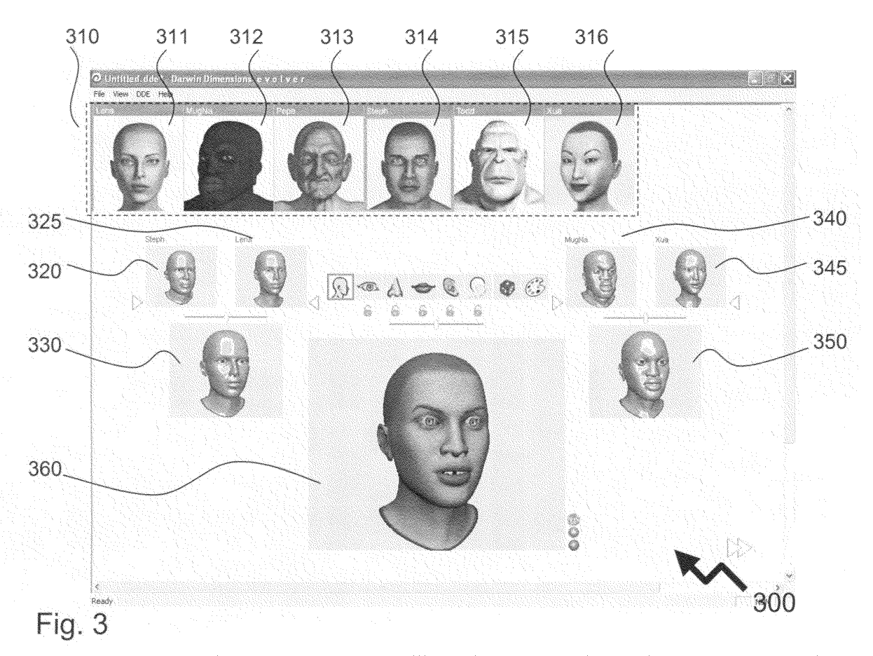

A developer of audio-visual content such as a video game or computer game comprising avatars, whether implementing avatars directly, such as discussed supra in respect of FIG. 1, or importing avatars from a commercial library such as presented supra in respect of FIG. 2A, will typically provide a user with an avatar selection page 250, such as is shown in FIG. 2B. Avatar selection page 250 is taken from the online virtual reality environment “Second Life,” as a specific and non-limiting example. Accordingly the user is provided with two groups, “Females” 260 comprising female avatars 261 through 266, and “Men” 270 comprising male avatars 271 through 276. The user has selected female avatar 266 from “Females” 260, the selected female avatar 266 is displayed complete as full FIG. 280 and name “Nightclub-Female”. A limitation of the approach presented in avatar selection page 250 is that only 12 avatars are provided to the user for selection, which may not seem overly limiting to one user, but “Second Life” as of May 2007 had over 6 million registered users within the virtual reality environment, approximately 500,000 of each “Female” 261 through 266 and “Male” 271 through 276. It would be beneficial to provide a way of rapidly generating avatars either from the viewpoint of an avatar generator, such as the programmer in FIG. 1 for individual characters, crowds, etc., or users within their gaming environment. It would be further beneficial to allow the individual generating the avatar to mimic, and simply adjust, weightings that occur within a genetically derived avatar generator that provides inheritance based development of an avatar. Such a three-generation inheritance based avatar generator 300 according to an embodiment of the invention for weighting grandparents for each parent and between parental families is shown in FIG. 3.

When employing the three-generation inheritance based avatar generator 300 a user selects four grandparents from a pool 310 of avatar characters. In the three-generation inheritance based avatar generator 300 the avatar characters are “Lena” 311, “MugNa” 312, “Pepe” 313, “Steph” 314, “Todd” 315, and “Xua” 316. In the instant example the user has selected “Steph” 314 as paternal grandfather 320, “Lena” 311 as paternal grandmother 325, “MugNa” 312 as maternal grandfather 340, and “Xua” 316 as maternal grandmother 345. The terms maternal and paternal as employed within the embodiments are to differentiate the two sets of grandparents. As will be evident in respect of the embodiments the requirement for both sexes in the parents giving “birth” to the child within a software based inheritance based avatar generator is not necessarily a requirement, although optionally it may be set as one. The three-generation inheritance based avatar generator 300 therein generates the second generation comprising “Parent 1” 330, and “Parent 2” 350, and thereafter the third generation avatar “Off-Spring Head” 360 of “Parent 1” 330 and “Parent 2” 350. It would be apparent that three-generation inheritance based avatar generator 300 provides the user with an additional aspect of their game, if embedded within a game, allowing their avatar to be determined from a plurality of choices and inputs rather than a single click of a cursor over one image.

Optionally, introducing the three-generation inheritance based avatar generator 300 into an online virtual reality environment such as “Second Life” as discussed supra in respect of FIG. 2B, allows for expansion of features such as allowing characters to procreate and have offspring, these offspring generated in accordance with predetermined or dynamically associated weightings from the environment, game status etc. Within the embodiment of the three-generation inheritance based avatar generator 300 the user is not required to select “male” characters for paternal grandfather 320 and maternal grandfather 340, and “female” characters for maternal grandmother 325 and maternal grandmother 345. Alternatively the three-generation inheritance based avatar generator 300 may place limitations on the characteristics of the avatar characters, such as avatar characters 311 through 316, such as sex, relatives having predetermined relationships, ethnicity, or being human, of defined “alien” race etc.

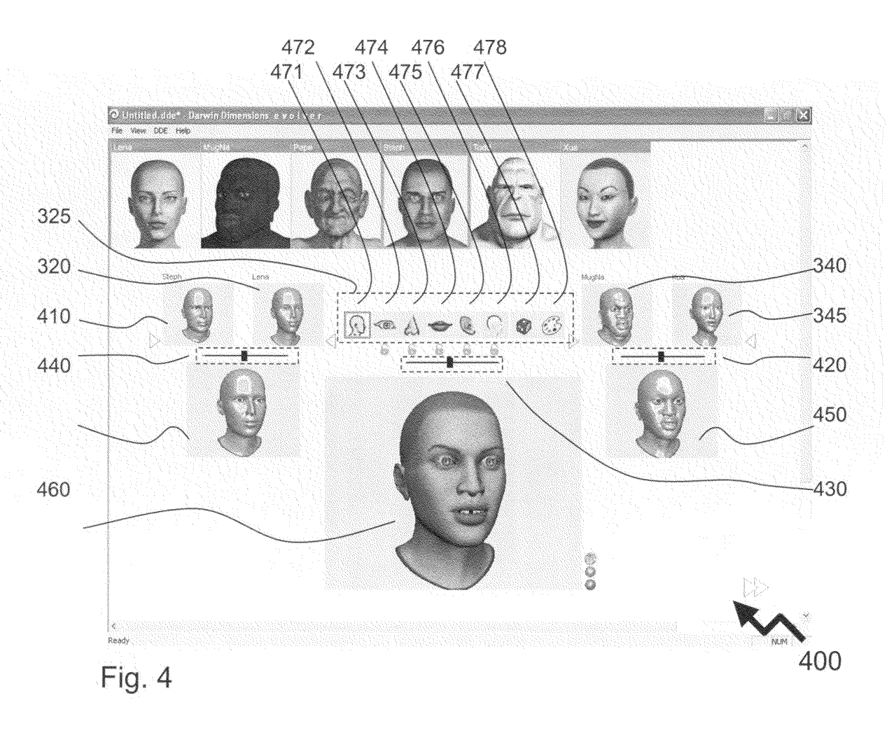

Referring now to FIG. 4, illustrated is the three-generation inheritance based avatar generator 400, equivalent to the three-generation inheritance based avatar generator 300 of FIG. 3, highlighting the slider-bars 410 through 430 having an indicating portion being set to an alternate weighting that favors the grandfathers. As such, within the three-generation inheritance based avatar generator 400 the avatar grandparents are “Steph” 314 as paternal grandfather 320, “Lena” 311 as paternal grandmother 325, “MugNa” 312 as maternal grandfather 340, and “Xua” 316 as maternal grandmother 345. In the instant example, the user has moved the paternal slider-bar 410 to the leftmost position, favoring the male grandparent “Steph” 314 on the paternal side, resulting in “Weighted Parent 1” 440. Similarly, maternal slider-bar 420 has been set to its leftmost position, favoring the male grandparent “MugNa” 312 on the maternal side, resulting in “Weighted Parent 2” 450. In this way, the user provides weighting factors for defining a relative contribution of at least one of the plurality of inheritable characteristics from each of the paternal grandparent avatars to a simulated physical appearance of “weighted Parent 1” 440, and for defining a relative contribution of at least one of the plurality of inheritable characteristics from each of the maternal grandparent avatars to a simulated physical appearance of “Weighted Parent 2” 450. The three-generation inheritance based avatar generator 400 uses “Weighted Parent 1” 440 and “Weighted Parent 2” 450 for generating weighted third generation avatar-off-spring 460. In generating the weighted third generation avatar-off-spring 460 the third generation inheritance based avatar generator 400 utilizes family weighting slide-bar 430 to adjust the weighting applied between “Weighted Parent 1” 440 and “Weighted Parent 2” 450.

Additional refinement of the avatar, once the grandparents and three sliders presented supra are defined, is possible via a feature selector bar 470 that is shown as comprising eight feature icons 471 through 478. The first feature icon being “Whole Head” 471, when selected provides the global avatar modifications as discussed supra in respect of FIG. 3 and FIG. 4 to date, when used in combination with family weighting slide-bar 430. The second feature icon “Eyes” 472 provides refinement of the eyes of the off-spring 460 through use of the central slider 430. Third through sixth feature icons being “Nose” 473, “Mouth” 474, “Ear” 475, and “Cranium” 476, each of which is used in combination with the family weighting slide-bar 430. Seventh feature icon “Random” 477 provides a randomization of all grandparents with the sliders 410 through 430 maintained at the levels set manually by the avatar generator. Finally, eighth feature icon “Palette” 478 allows the aviator generator to change the skin palette of the off-spring 460 to that of any one of source characters within the pool 310. For example, “MugNa” 312 is of dark complexion, “Xua” 316 is of light complexion, and “Todd” 315 is colored blue for an alien species. As such simply by selecting the eighth feature icon “Palette” 478 the avatar generator is provided with a second window, not shown for clarity, showing the pool 310 allowing the avatar generator to select the character for the skin tone.

The three-generation inheritance based avatar generator of the exemplary embodiments presented in respect of FIGS. 3 through 4 for the head of the avatar is a first step, as the avatar generator would need to generate a body also. Such an exemplary second step is shown in the three-generation inheritance based avatar generator 500. Now shown to the avatar generator is the pool 510, but now each body is shown in full modesty level nudity. As such shown are “Lena” 511, “MugNa” 512, “Pepe” 513, “Steph” 514, “Todd” 515, and “Xua” 516, wherein again the avatar grandparents are “Steph” 514 as paternal grandfather 520, “Lena” 511 as paternal grandmother 525, “MugNa” 512 as maternal grandfather 540, and “Xua” 516 as maternal grandmother 545. These give rise to “Body Parent 1” 530 and “Body Parent 2” 550 in the second generation and “Off-Spring” 560, in the same manner as presented supra using “Body Paternal Slider” 582, “Body Maternal Slider” 586 and “Body Weighting Slider” 584.

Also shown are “Body Slider” 578 and three body feature icons, “Head-Body Ratio” 572, “Scale Neck” 574, and “Height” 576. The avatar generator in selecting “Height” 576 can scale the whole body of “Off-Spring” 560 across the pre-determined range defined in conjunction with the “Body Slider” 578, for example from 0.4 m (approximately 16 inches) for an infant through to 2.4 m (approximately 7 feet 10 inches). Similarly, “Scale Neck” 574 allows the avatar generator to adjust the length of the neck of “Off-Spring” 560, and “Head-Body Ratio” 572.

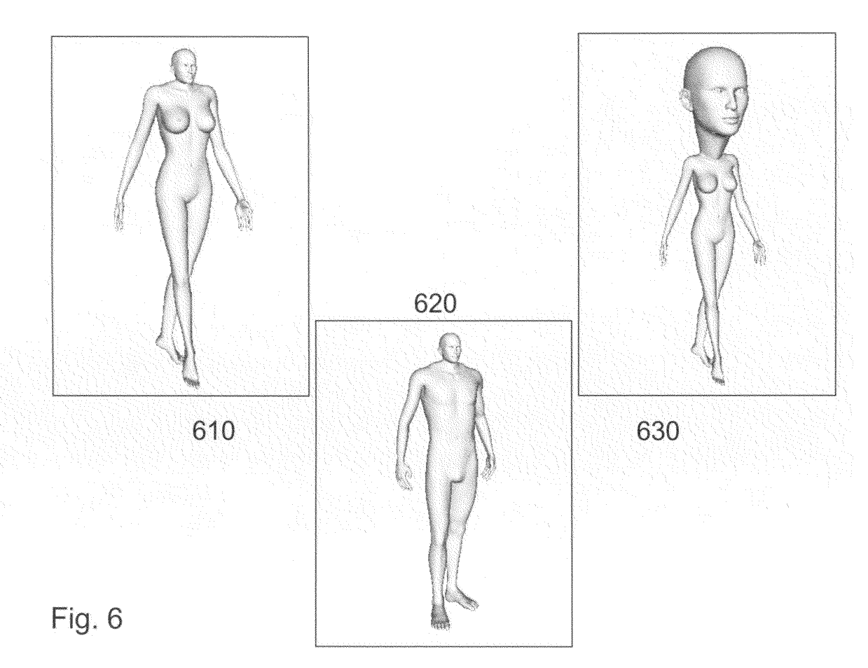

Exemplary avatars generated when the avatar generator has selected “Head-Body Ratio” 572 and manipulated “Body Slider” 578 are shown in FIG. 6. Shown on the left is “Shrunken Head” 610 wherein the ratio of head to body has been set to a low value, i.e. small head for given body size, using the body of “Off-Spring” 560. Shown next in the middle is “Steroid Man” 620 wherein the maternal grandfather used is “Todd” 515, the weightings favor male grandparents, and the maternal grandparents, and “Body Slider” 578 at low ratio. Finally, shown on the right is “Bloated Head” 630 wherein “Off-Spring” 560 formed the starting avatar and “Body Slider” 578 has been adjusted to the other extreme with “Head-Body Ratio” 572 selected.

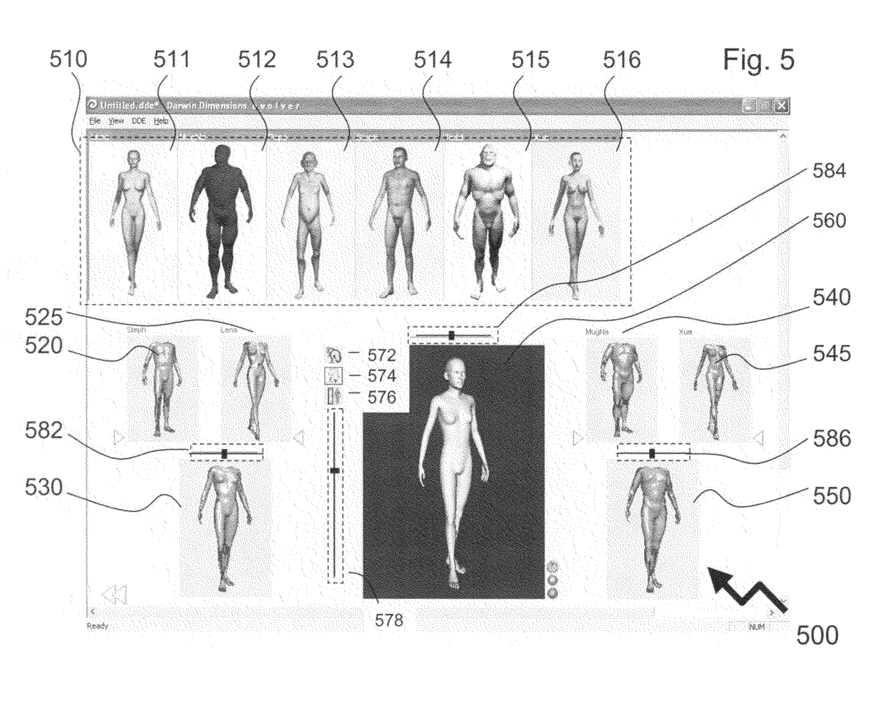

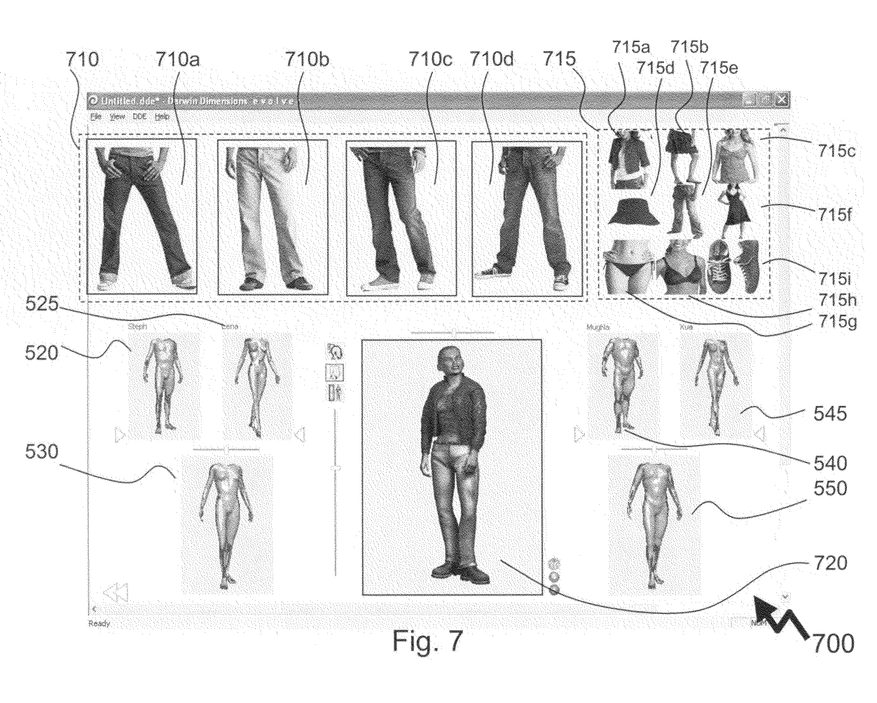

Referring now to FIG. 7, illustrated is a three-generation inheritance based avatar generator 700 illustrating the third step of providing non-physical features of “Off-Spring” 560, such as for instance an additional item for being associated with the avatar, e.g. at least one of clothing, tattoos, body jewelry, body piercing, scars, body hair, body augmentation, and surgical scars. The additional item does not include a texture relating to the “Off-Spring” 560. Accordingly, shown are aspects from the second step of the body generation, such as shown supra in respect of FIG. 5, and the non-physical feature selection aspects comprising non-physical feature selector 715 and option bar 710 for the selected feature within non-physical feature selector 715. As such the bodies of the “Steph” 514 as paternal grandfather 520, “Lena” 511 as paternal grandmother 525, “MugNa” 512 as maternal grandfather 540, and “Xua” 516 as maternal grandmother 545 are shown together with “Body Parent 1” 530 and “Body Parent 2” 550 in the second generation. However, the torso of “Off-Spring” 560 has now been replaced by the full avatar body 720 with previously and currently selected non-physical features. As such the full avatar body 720, without any non-physical feature selections would comprise torso “Off-Spring” 560 with “Off-Spring Head” 360.

Accordingly the avatar animator is provided with non-physical feature selector 715 which comprises a series of icons 715a through 715i relating to categories of non-physical features. As shown, the icons relate to clothing for a female avatar and are “Jacket” 715a, “Skirt” 715b, “Blouse” 715c, “Hat” 715d, “Trousers” 715e, “Dress” 715f, “Lingerie” 715g, “Bra” 715h, and “Shoes” 715i. Having selected “Trousers” 715e the option bar 710 displays all, or optionally a sub-set, of options. In this view of the three-generation inheritance based avatar generator 700 the option bar 710 displays “Jeans—Standard” 710a, “Curvy Low Rise” 710b, “Pants—Tight” 710c, and “Jeans—Boot Cut” 710d.

In selecting each category of non-physical features, from non-physical feature selector 715, and specific option, from option bar 710, the full body avatar 720 is re-displayed with the selected item. Importantly, the three-generation inheritance based avatar generator 700 automatically resizes and maps the selected item, such as Jeans-Standard” 710a to the full body torso (being full body avatar 720 without any additional features). In this manner an adjustment in the full body avatar 720 arising from a change in the multiple selections the avatar generator can make, including paternal grandparents 320 and 325, maternal grandparents 340 and 345, paternal grandparent weighting via paternal slider 410, maternal grandparent weighting via maternal slider 420, father-mother weighting via family weighting slide-bar 430, and the eight feature icons 471 through 478.

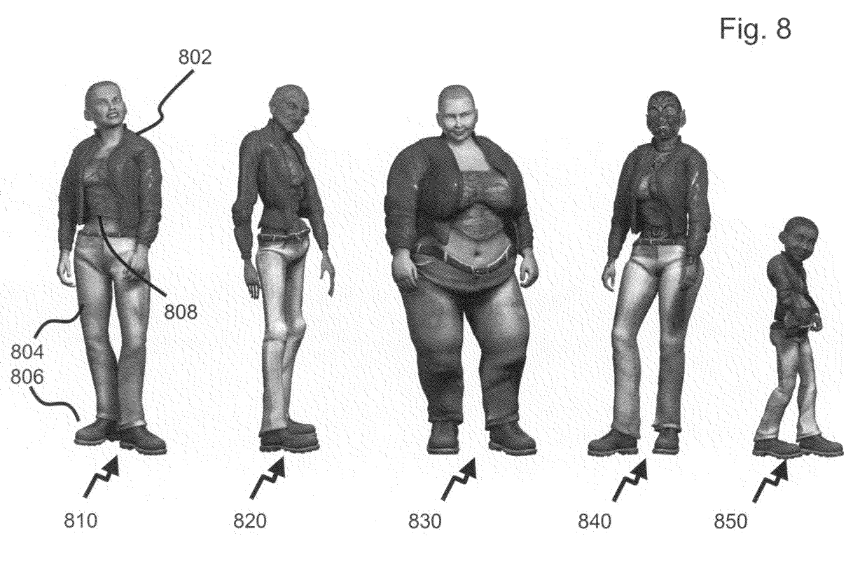

In this manner, as illustrated in FIG. 8 the three-generation inheritance based avatar generator output automatically maps these non-physical features to the adjustments in the avatar from the first and second steps relating to the physical characteristics, which can be substantial changes in the avatar given the selections and weightings the avatar generator can make. As shown within FIG. 8 the non-physical features comprise “Blue Denim Jacket” 802, selected with non-physical feature selector 715 icon “Jacket 715a” and appropriate option from option bar 710, “Washed Blue Jeans” 804 using icon “Trousers” 715e, “Brown Boots” 806 using icon “Shoes” 715i, and “Camouflage Tank” 808 using icon “Blouse” 715c. Avatars employing these non-physical features 802 through 808 automatically mapped to their torsos are “Human Female” 810, “Old Alien Male” 820, “Big Woman” 830, “Alien Female” 840, and “Boy” 850.

In this manner, according to at least an embodiment of the invention, the selection of non-physical features genuinely is a “one-size-fits-all” selection of clothing or other elements provided within the option bar 710 and routed through non-physical feature selector 715. Optionally, each non-physical feature may be provided with a palette change, as discussed supra in respect of the skin tone of the off-spring 460 using “Palette” 478 in respect of FIG. 4. In this manner, non-physical feature selector 715 and option bar 710 optionally provide for selection of styles, shapes, or other aspects of non-physical features which are then adjusted in relation of a palette feature in color, pattern etc. Aspects of the full body avatar 720 arising from lighting, posture etc. would be provided by subsequent processing in respect of the animations applied to the avatar generated.

In the embodiments of the invention presented supra the inheritance based avatar generation process has been presented in respect of a human procreation model with two parents for each off-spring and weighting applied between each pair of parents within each of the first and second generations giving rise to the third generation. Whilst the weightings applied have been discussed in respect of slider bars it would be apparent that alternative methods of user selection of the weighting are possible, including implementations of dials, knobs, etc and entry by the user of a percentage, ratio or other indicator.

Optionally, the inheritance based avatar generator may be implemented with N parents, wherein N>2, for each offspring, and a weighting Wₘ is provided by the user for all but one parent, i.e. providing N−1 weightings, where

$${\sum }_{m = 1}^{N} {W}_{m} = 1.$$

The final weighting being automatically calculated. Alternatively the user may also be provided with a random weighting function, wherein a pseudo-random number generator provides the weightings for the current selection of parents. It would also be apparent that the avatar generator may select any combination of parents, and hence whilst the embodiments supra employ human, or humanoid, parents such a limitation is only for ease of presentation and understanding. No such limitation exists for the avatar generator other than the avatars within the pool have formats compatible with the inheritance based avatar generator process.

Further optionally, the inheritance based avatar generator supports inheritance of “recessive” characteristics. This is, essentially, another form of randomization. Thus, according to an aspect of the instant invention the “Random” 717 feature may be used to support toggling of the “recessive” characteristics on and off. For instance, at least some of the grandparent and/or parent avatars possess “recessive” characteristics within their definition. These are characteristics that typically are not visually apparent in the said avatar's simulated physical appearance, but which nevertheless are capable of being “passed on” to subsequent generations of avatars. When two avatars having such “recessive” characteristics are combined, then there is a statistically determined probability that the resulting Off-Spring avatar will express the characteristic in its simulated physical appearance. For instance, the Off-Spring avatar may be unexpectedly a red-head, even though none of the ancestor avatars has red hair. Of course, should the user decide to disable “recessive” characteristics using, for instance, the “Random” 717 feature, then the same avatar would instead have hair color that is determined as a weighted average of the hair color of the ancestor avatars, as described supra.

When “recessive” characteristics are enabled, then at least two avatars of an available pool of avatars have at least one physical characteristic that includes a “recessive variant.” Optionally, the “recessive variant” is the same for each of the at least two avatars, such than any Off-Spring thereof expresses the “recessive variant,” without any weighting to favor any of the at least two avatars. Further optionally, each of the at least two avatars has a uniquely defined “recessive variant.” For instance, continuing the red head example, the “recessive variant” for one of the at least two avatars results in dark auburn hair and the “recessive variant” for the other of the at least two avatars results in bright red hair. The user optionally uses a weighting bar to favor the “recessive variant” of one of the at least two avatars, thereby selecting a hair color intermediate dark auburn and bright red.

Off-Spring avatars, which are generated using an avatar generator according to an embodiment of the instant invention, may be used to “populate” interactive or non-interactive applications, such as for instance video and computer games, on-line virtual environments for social networking or dating, movies, advertisements, etc. In the case of on-line gaming and on-line virtual environments, optionally the avatar generator is hosted on a computer system that is remote from the user, or the avatar generator is downloaded to a computer system that is local to the user. For instance, the avatar generator may be downloaded as part of the initial software download by a new user upon joining an on-line virtual environment or on-line gaming community. The parameters that define the generated Off-Spring avatar may be transferred from the user's local computer system to the local computer systems of other users that interact with the user within the virtual environment. Software that is installed on the local computer systems of the other users then generates a representation of the Off-Spring avatar, based on the parameters received from the user.

What is claimed is:

1. A method comprising:
providing at least two avatars, each one of the at least two avatars having a different simulated physical appearance that is defined in terms of a plurality of inheritable characteristics;
providing a weighting factor for defining a relative contribution of at least one of the plurality of inheritable characteristics from each of the at least two avatars to a simulated physical appearance of an Off-Spring avatar, the weighting factor selected by a user;
generating the Off-Spring avatar in dependence upon the plurality of inheritable characteristics of the at least two avatars and the weighting factor;
providing an additional item for being associated with the Off-Spring avatar;
modifying the Off-Spring avatar to form a new avatar, the new avatar formed by mapping the additional item onto the Off-Spring avatar; and
storing the new avatar on a computer readable storage medium.

2. A method according to claim 1, wherein mapping the additional item onto the Off-Spring avatar comprises resizing the additional item in dependence upon the weighting factor.

3. A method according to claim 1, wherein the additional item is other than a texture relating to the Off-Spring avatar and is selected from a group of additional items consisting of clothing, tattoos, body jewelry, body piercing, scars, body hair, body augmentation, and surgical scars.

4. A method according to claim 1, wherein the additional item is the body color of a source avatar, the source avatar being other than one of the at least two avatars.

5. A method according to claim 1, wherein providing the additional item for being associated with the Off-Spring avatar comprises displaying to the user an additional item category-selector and an additional item option-selector, the additional item option-selector for displaying a plurality of additional items of a selected category of additional items.

6. A method according to claim 5, comprising displaying the simulated physical appearance of the new avatar proximate to the displayed additional item category-selector and the additional item option-selector.

7. A method according to claim 6, comprising, in dependence upon the user selecting a different additional item, displaying an updated simulated physical appearance of the new avatar, the updated simulated physical appearance being formed by mapping the different additional item onto the Off-Spring avatar.

8. A method according to claim 6, wherein providing the weighting factor comprises selecting a value within an available range of values for the at least one of the plurality of inheritable characteristics, the available range of values having a first endpoint corresponding to one of the at least two avatars and having a second endpoint corresponding to the other one of the at least two avatars.

9. A method according to claim 8, wherein providing a weighting factor comprises adjusting a slider bar indicating-portion to a location that is between opposite ends of the slider bar.

10. A method according to claim 9, comprising displaying to the user the slider bar disposed between displays of the simulated physical appearance of each of the at least two avatars, such that moving the slider bar indicating-portion in a direction toward the display of the simulated physical appearance of one of the at least two avatars weights more heavily toward the one of the at least two avatars, and such that moving the slider bar indicating-portion in a direction toward the display of the simulated physical appearance of the other of the at least two avatars weights more heavily toward the other of the at least two avatars.

11. A method according to claim 9, comprising displaying an updated simulated physical appearance of the new avatar, including automatically resizing the additional item in dependence upon the user varying the location of the slider bar indicating-portion and mapping the resized additional item onto the Off-Spring avatar.

12. A method comprising:
(a) providing a current generation of avatars comprising at least two different avatars, each of the at least two different avatars having at least one physical characteristic contributing to a unique simulated physical appearance thereof;
(b) receiving from a user a weighting factor for establishing a weighting in combining the at least one physical characteristic of the at least two different avatars of the current generation of avatars;
(c) executing an inheritance based avatar generation process for generating a next generation avatar, the at least one physical characteristic of the next generation avatar being established in dependence upon the at least one physical characteristic of the at least two different avatars of the current generation of avatars and the weighting factor;
(d) providing an additional item for being associated with the next generation avatar;
(e) providing a new avatar, the new avatar being generated by mapping the additional item onto the next generation avatar; and
(f) storing the new avatar on a computer readable storage medium.

13. A method according to claim 12, wherein receiving from the user a weighting factor comprises providing an inheritance slider, and wherein the user adjusts the position of a slider bar indicating-portion for providing an indication of the weighting factor.

14. A method according to claim 12, wherein the additional item is other than a texture relating to the next generation avatar and is selected from a group consisting of clothing, tattoos, body jewelry, body piercing, scars, body hair, body augmentation, and surgical scars.

15. A method according to claim 12, wherein providing the current generation of avatars comprises:
providing a previous generation of avatars comprising a first pair of avatars and a second pair of avatars, each avatar of the previous generation of avatars having at least one physical characteristic contributing to a simulated physical appearance thereof, and, executing an inheritance based avatar generation process for generating a first avatar as a weighted combination of the first pair of avatars and for generating a second avatar as a weighted combination of the second pair of avatars, the first and second avatars forming at least a portion of the current generation of avatars.

16. A method according to claim 15, wherein the first and second avatars are the at least two different avatars of the current generation of avatars.

17. A method according to claim 15, wherein the additional item is an additional item previously associated with one of the avatars.

18. A method according to claim 15, wherein the additional item is selected from a pool of items, the pool of items being items previously associated with an avatar of at least one of the previous generation of avatars and the current generation of avatars.

19. A method according to claim 15, comprising providing a first inheritance slider and a second inheritance slider, wherein the user uses the first inheritance slider for providing a first weighting factor for establishing the weighting in combining the avatars of the first pair of avatars and wherein the user uses the second inheritance slider for providing a second weighting factor for establishing the weighting in combining the avatars of the second pair of avatars.

20. A method according to claim 19, comprising providing a third inheritance slider, wherein the user uses the third inheritance slider for establishing the weighting in combining the at least two different avatars of the current generation of avatars.

21. A method according to claim 15, comprising providing an inheritance slider, wherein the user uses the inheritance slider for establishing the weighting in combining the at least two different avatars of the current generation of avatars.

22. A method according to claim 12, wherein storing in a computer readable medium data relating to the physical characteristics of the next generation avatar further comprises storing data relating to the additional item.

23. A method according to claim 22, wherein performing a subsequent inheritance based avatar process is adjusted in dependence of data stored relating to additional item.

24. A method comprising:
providing a virtual environment, the virtual environment supporting a plurality of avatars associated with a plurality of users, each avatar having a plurality of physical characteristics;
providing within the virtual environment an ability for at least two avatars of the plurality of avatars to have an Off-Spring avatar, the Off-Spring avatar generated in dependence upon the plurality of physical characteristics of the at least two avatars;
providing an additional item for being associated with the Off-Spring avatar, the additional item being selected by at least one user associated with the at least two avatars;
modifying the Off-Spring avatar to provide a modified Off-Spring avatar, the modified Off-Spring avatar generated by mapping the additional item onto the Off-Spring avatar, and
storing the modified Off-Spring avatar on a computer readable storage medium.

25. A method according to claim 24, wherein the additional item is other than a texture relating to the Off-Spring and is selected from a group consisting of clothing, tattoos, body jewelry, body piercing, scars, body hair, body augmentation, and surgical scars.
